(19) United States
(12) Patent Application Publication
(10) Pub. No.: US 2025/0083576 A1
(43) Pub. Date: Mar. 13, 2025

(54) Adjusting device comprising a coupling element

(71) Applicant: Brose Fahrzeugteile SE & Co. Kommanditgesellschaft, Coburg, Coburg (DE)

(72) Inventors: Jano FAUSKA, Coburg (DE); Jens GEMEINHARDT, Rödental (DE)

(21) Appl. No.: 18/827,560

(22) Filed: Sep. 6, 2024

(30) Foreign Application Priority Data
Sep. 7, 2023 (DE) 10 2023 124 143.5

(51) Int. Cl. B60N 2/08; B60N 2/02; B60N 2/90

(52) U.S. Cl. CPC B60N 2/085; B60N 2/02246; B60N 2/919

(57) ABSTRACT

It is provided an adjusting device for a vehicle seat, comprising: a pivot lever pivotable about a pivot axis for adjustably mounting a seat part of the vehicle seat on a base of the vehicle seat, a drive element and a coupling element, which is movably mounted between a coupling position in which the coupling element builds up a coupling between the drive element and the pivot lever for pivoting the pivot lever about the pivot axis, and a decoupling position in which the coupling of the pivot lever with the drive element via the coupling element is released.

### CROSS REFERENCE TO RELATED APPLICATION

The present application claims priority to German Patent Application No. 10 2023 124 143.5 filed on Sep. 7, 2023. The entire contents of the above-listed application are hereby incorporated by reference for all purposes.

### BACKGROUND

The proposed solution relates to an adjusting device for a vehicle seat and to a vehicle seat.

In vehicles, several rows of vehicle seats mostly are provided. In many cases, less doors than seat rows are provided per side of the vehicle, so that e.g. in some cases a second seat row as seen from the front is accessible via the driver or passenger door. In other examples of vehicles with three seat rows it often is provided that the third seat row is accessible via doors of the second seat row. To facilitate entry into the rear seat row, it regularly is provided that the seats of the respectively front seat row can be displaced from a position of use to be occupied into an entry position. The entry position typically is referred to as easy-entry position. In this position, the backrest and/or the seat part of a seat are displaced to the front with respect to the position of use, in order to open a greater access to the seat row located there behind and hence ensure a comfortable entry.

Entry into the rear seat row and exit from the rear seat row are possible particularly comfortably when the vehicle seat arranged before the same is electrically adjustable into the easy-entry position.

However, when e.g. an electric drive motor fails in such embodiments, in particular an exit from the rear seat row can be made distinctly more difficult. To still provide for an easy entry and exit also in such cases, there can be provided e.g. an additional manual unlocking of the backrest by means of an actuating lever, as it is described in DE 10 2005 031 968 A1. The construction of the vehicle seat, however, becomes more complex due to an additional mechanism.

It is the object to indicate an improved adjusting device.

This object is achieved by an adjusting device having features as described herein.

Accordingly, there is indicated an adjusting device for a vehicle seat, comprising: a pivot lever pivotable about a pivot axis for adjustably mounting a seat part of the vehicle seat on a base of the vehicle seat, a drive element, and a coupling element. The coupling element is movably mounted between a coupling position and a decoupling position. In the coupling position, the coupling element builds up a coupling between the drive element and the pivot lever for pivoting the pivot lever about the pivot axis by means of the drive element. In the decoupling position, the coupling of the pivot lever with the drive element via the coupling element is released.

This is based on the finding that a for instance manual adjustment of the pivot lever on failure of a drive driving the drive element is possible in a particularly simple way when the drive element can be decoupled from the pivot lever when necessary. For example, an adjustment into an easy-entry position can also be made on failure of the drive, without an additional mechanism being necessary for this purpose, but there can be used the same mechanism as in the adjustment by a drive for the drive element. It is possible to provide an adjusting device which is improved in particular to the effect that it provides for an adjustment of the pivot lever with few components and with a simple construction. In the decoupling position, the pivot lever can be pivoted e.g. relative to the drive element.

The coupling element can be shiftably mounted between the coupling position and the decoupling position, in particular be shiftably mounted relative to the pivot lever and/or relative to the drive element. This allows a simple displacement between the coupling position and the decoupling position.

The drive element can be configured in the form of a gear wheel. For example, a motor unit can be connected in a simple way in order to drive the drive element.

For example, the drive element is rotatably mounted on a (physical) axle. This provides for a simple and robust construction. On the axle, e.g. the pivot lever is (firmly or pivotably) mounted.

The coupling element can be shiftable along the axle between the coupling position and the decoupling position. In this way, the coupling element and the drive element can be loadably coupled with each other with a simple construction.

The adjusting device furthermore can comprise a decoupling element. The decoupling element can be rotatable about the axle relative to the coupling element. The decoupling element can be in engagement with the coupling element in particular in such a way that the coupling element is movable between the coupling position and the decoupling position by a movement of the decoupling element, e.g. along the axle. This provides for a particularly easy displacement of the coupling element from the coupling position into the decoupling position.

The decoupling element can include one or more portions, e.g. arms, which encloses/enclose the coupling element. The decoupling element can pull the coupling element out of the coupling position, in particular in a robust and simple way.

The decoupling element can include a slope. The slope can rest against a slope fixed to the axle. This provides for a transfer of a rotation of the decoupling element into an axial displacement of the decoupling element and hence for a particularly easy actuation.

The adjusting device can comprise a Bowden cable coupled with the decoupling element. The same for example is adapted to put the decoupling element into a rotation. This provides for a particularly easy actuation.

For example, the axle defines the pivot axis. The axle can extend coaxially to the pivot axis. The construction of the adjusting device thereby can be simplified further.

It can be provided that the coupling element in the coupling position positively is in engagement with the drive element and/or is positively coupled with the pivot lever. In the coupling position, the coupling element can be positively in engagement with the drive element and can be positively coupled with the pivot lever in such a way that a torque applied onto the drive element can be transmitted to the pivot lever via the coupling element for pivoting the pivot lever about the pivot axis. This provides for a drive via the drive element in a simple way.

Furthermore, it can be provided that in the decoupling position the coupling element is out of engagement with the drive element and is rotatable relative to the drive element. The pivot lever thus can be moved independently of the drive element, i.e. in particular also in the case of a failure of a drive of the adjusting device, such as a motor unit.

The coupling element can include one or more form-fitting portions, e.g. in the form of pins for engagement with one or more corresponding form-fitting portions, e.g. in the form of openings, of the drive element for building up the coupling of the pivot lever with the drive element via the coupling element in the coupling position. In this way, a loadable and long-lived coupling between the drive element and the coupling element can be achieved.

For example, it is provided that the coupling element in the coupling position and/or in the decoupling position is in engagement with (at least) one pin attached to the pivot lever. In this way, a loadable and long-lived coupling between the drive element and the pivot lever can be achieved.

The coupling element can be pretensioned into the coupling position, e.g. by means of a spring, such as a spiral spring. In the normal case, the drive element is coupled with the pivot lever, and this coupling can be released only when necessary.

Furthermore, the adjusting device can comprise a motor unit adapted for driving the drive element. This allows a particularly comfortable entry and exit in a vehicle with a vehicle seat comprising the adjusting device. The motor unit comprises e.g. an electric motor and a transmission. The motor unit e.g. is adapted to put the drive element into a rotation, for example by means of a pinion.

According to one aspect there is indicated a vehicle seat, comprising a seat part, a base and the adjusting device according to an arbitrary configuration described herein. It can be provided that the seat part is supported on the base via the pivot lever of the adjusting device. As regards the advantages, reference is made to the above indications concerning the adjusting device.

The adjusting device for example comprises at least one further pivot lever. The same forms e.g. a four-bar linkage with the pivot lever. This allows a particularly precise adjustment of the seat part (and of a backrest mounted thereon), in particular also via a particularly long path for clearing a large entry and exit area.

The adjusting device can comprise an actuating portion and/or a locking mechanism. By means of the locking mechanism, e.g. the seat part can be locked with the base. By actuating the actuating portion, both the locking mechanism can be unlockable and the coupling element can be movable into the decoupling position. The actuating portion e.g. is connected to a plurality of Bowden cables, one of which is coupled with the locking mechanism and one with the adjusting device.

By means of the adjusting device, the seat part can be movable together with a backrest of the vehicle seat from a position of use to be occupied into an entry position moved forwards relative thereto with respect to the base, in particular folded forwards, also referred to as an easy-entry position.

### BRIEF DESCRIPTION OF THE DRAWINGS

The idea underlying the solution will be explained in detail below with reference to the exemplary embodiments illustrated in the Figures.

FIG. 1A shows a vehicle seat in a position of use to be occupied.

FIG. 1B shows the vehicle seat of FIG. 1B in an entry position moved forwards.

FIG. 2A shows an adjusting device of the vehicle seat in the position of FIG. 1A.

FIG. 2B shows the adjusting device of FIG. 2A in the position of the vehicle seat of FIG. 1B.

FIG. 3 shows another view of the adjusting device of FIG. 2A.

FIG. 4 shows an exploded view of the adjusting device of FIG. 2A;

FIGS. 5 and 6 show further views of the adjusting device of FIG. 2A, wherein the adjusting device is shown in a coupling position.

FIGS. 7 and 8 show further views of the adjusting device of FIG. 2A, wherein the adjusting device is shown in a decoupling position.

FIG. 9 shows a detail view of the adjusting device of FIGS. 5 and 6.

FIG. 10 shows a detail view of the adjusting device of FIGS. 7 and 8.

### DETAILED DESCRIPTION

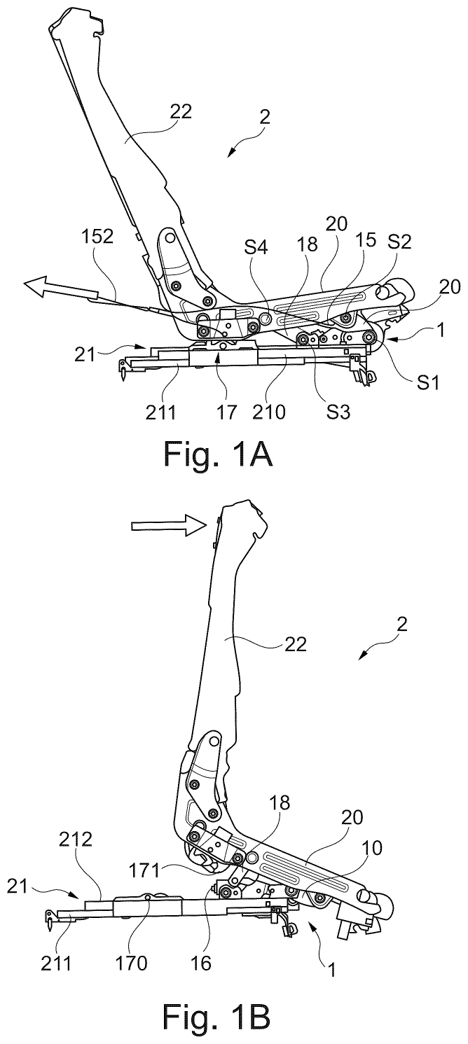

FIG. 1A shows a vehicle seat 2 comprising a seat part 20 and a backrest 22. The backrest 22 is mounted on the seat part 20. The vehicle seat 2 can be mounted on a vehicle floor of a vehicle by means of a base 21. The base 21 carries the remaining vehicle seat 2.

In the present case, the base 21 by way of example is configured in the form of a longitudinal adjustment device and allows a longitudinal adjustment of the vehicle seat 2 along a longitudinal vehicle axis. By means of the longitudinal adjustment device, the seat part 20 and the backrest 22 can jointly be shifted relative to the vehicle floor along the longitudinal vehicle axis. The longitudinal vehicle axis is aligned perpendicularly to a vehicle height axis and perpendicularly to a vehicle width axis. The base 21 comprises two pairs each including one rail to be fixed to the vehicle floor, which can also be referred to as floor rail 211, and one seat rail 210 shiftably mounted thereon along the longitudinal vehicle axis. The remaining vehicle seat 2 is mounted on the seat rail 210. The two pairs, only one of which is visible in the side view of FIG. 1A, are spaced apart from each other along the vehicle width axis. The vehicle width axis is aligned perpendicularly to the longitudinal vehicle axis and perpendicularly to the vehicle height axis.

The vehicle seat 2 furthermore comprises an adjusting device 1. The adjusting device 1 connects the seat part 20 with the base 21. The adjusting device 1 carries the seat part 20 on the base 21. For this purpose, the adjusting device 1 comprises a pivot lever 10 and, in the illustrated example, also a further pivot lever 18. From the perspective of a passenger sitting on the vehicle seat 2, the pivot lever 10 is arranged at the front, the further pivot lever 18 further back. The seat part 20 has a rear end facing the backrest 22 and a front end facing away from the backrest 22. The pivot lever 10 is arranged closer to the front end of the seat part 20 than the further pivot lever 18. For easier reference, the pivot lever 10 subsequently will also be referred to as front pivot lever 10, the further pivot lever 18 as rear pivot lever 18.

The front pivot lever 10 is pivotally mounted on the base 21, here on the seat rail 210, about a first pivot axis S1. For this purpose, a holder is attached to the seat rail 210, on which the front pivot lever 10 is pivotally mounted. Furthermore, the front pivot lever 10 is pivotally mounted on the seat part 20 about a second pivot axis S2. A pivotal movement of the front pivot lever 10 relative to the base about the first pivot axis S1 thus effects an adjustment of the seat part 20 relative to the base 21.

The rear pivot lever 18 is pivotally mounted on the base 21, here on the seat rail 210, about a third pivot axis S3. For this purpose, a holder is attached to the seat rail 210, on which the rear pivot lever 18 is pivotally mounted. Furthermore, the rear pivot lever 18 is pivotally mounted on the seat part 20 about a fourth pivot axis S4. The numbering of the pivot axes S1-S4 indicated here merely serves for easier reference.

The two pivot levers 10, 18 form a four-bar linkage jointly with the base 21 and the seat part 20. The vehicle seat 2 likewise comprises two pivot levers on the other (left) side, which are configured and arranged analogously (or alternatively as mirror images) to the two pivot levers 10, 18 visible in FIG. 1A. The vehicle seat 2 hence comprises one four-bar linkage each on both sides.

FIG. 1A shows the vehicle seat 2 in a position of use to be occupied, in which a passenger can sit down on the vehicle seat 2. To permit an easier entry and exit into a seat row located behind the vehicle seat 2, the vehicle seat 2 can be folded forwards by means of the adjusting device 1 from the position of use shown in FIG. 1A into an entry position, also referred to as easy-entry position, shown in FIG. 1B.

In the position of use, the pivot levers 10, 18 point from the base 21 to the rear in the direction of the backrest 22. In the easy-entry position, the pivot levers 10, 18 on the other hand point to the front. The seat part 20 and the backrest 22 in the easy-entry position thereby not only are inclined to the front, but also in general shifted further to the front. As a result, a particularly large area is cleared for an entry and exit.

To effect an adjustment of the vehicle seat 2 between the position of use and the easy-entry position, the adjusting device 1 comprises a motor unit 16. The motor unit 16 comprises an electric motor and a transmission. The motor unit 16 is operatively connected to the front pivot lever 10 and adapted to pivot the same about the first pivot axis S1 relative to the base 21.

Furthermore, the adjusting device 1 comprises a locking mechanism 17. By means of the locking mechanism 17, the seat part 20 can be locked with the base 21, in the present case with the seat rail 210.

In the example of FIGS. 1A and 1B, one bolt 170 each therefor is attached to each of the seat rails 210. For each bolt 170, a lock 171 aligned with the respective bolt 170 is mounted on the seat part 20. The locks 171 are arranged at the rear end of the seat part 20, which adjoins the backrest 22. The locks 171 each include a hook which is adapted to engage behind the respective bolt 170, so as to effect locking. The locks 171 can be opened, in the present case by means of an electric actuator (or by one each).

To displace the vehicle seat 2 from the position of use as shown in FIG. 1A into the easy-entry position as shown in FIG. 1B, the locking mechanism 17 can be opened electrically and the front pivot lever 10 can be pivoted by means of the motor unit 16. Conversely, the vehicle seat 2 can be transferred from the easy-entry position into the position of use by initially pivoting the front pivot lever 10 back by means of the motor unit 16 and then the locks 171 being locked by means of the bolts 170.

However, when the drive unit 16 now fails, for example due to a defect of the motor or a failure of the power supply of the motor unit 16, the vehicle seat 2 no longer is electrically adjustable between the position of use and the easy-entry position. To nevertheless be able to effect such an adjustment for example in such cases, the locking device 1 includes a coupling mechanism described in more detail below. In the illustrated example an actuating portion 152 is provided, which can be actuated manually in order to provide for a manual adjustment between the position of use and the easy-entry position. In the present case, the actuating portion 152 by way of example is configured in the form of a hand strap. The same is coupled with a plurality of Bowden cables 15, in the present case with a Bowden cable 15 to the coupling mechanism and one Bowden cable 15 each to each of the two locks 171. An actuation (here: a pull) of the actuating portion 151 thus at the same time effects unlocking of the locks 171 and decoupling of the motor unit 16 from the front pivot lever 10.

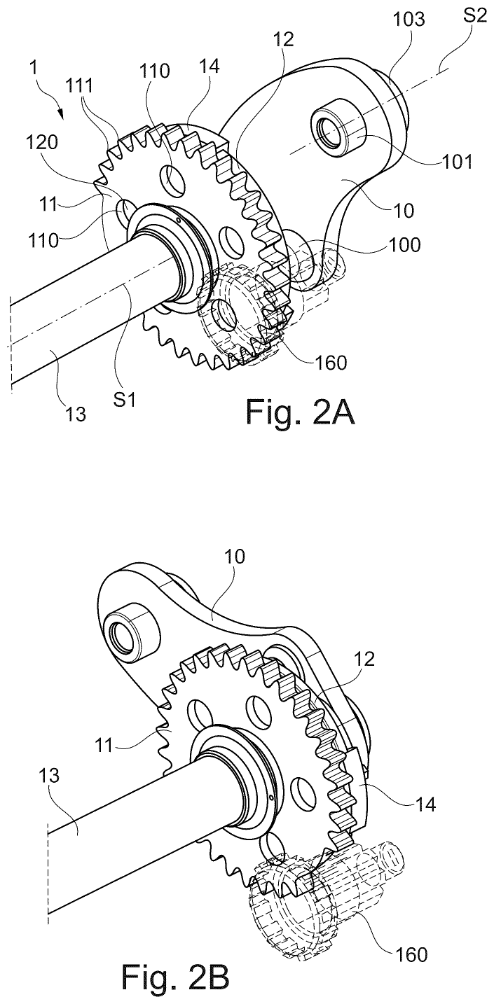

FIGS. 2A and 2B show the adjusting device 1 in the positions of the vehicle seat 2 as shown in FIG. 1A (FIG. 2A) and as shown in FIG. 1B (FIG. 2B), respectively.

The adjusting device 1 of the vehicle seat 2 comprises the front pivot lever 10 pivotally mounted on the base 21 about the first pivot axis S1 for adjustably mounting the seat part 20 of the vehicle seat 2 on the base 21, which has already been described above.

Furthermore, the adjusting device 1 comprises a drive element 11 which in the present case is configured in the form of a gear wheel with a plurality of teeth 111. The teeth 111 form an external toothing. The drive element 11 with its teeth 111 is in engagement with teeth of a pinion 160 of the motor unit 16. The pinion represents a part of the transmission of the motor unit 16 and is driven by the motor of the motor unit 16. An activation of the motor unit 16 thus effects a rotation of the drive element 11. The drive element 11 in the present case is rotatably mounted about an axle 13 which in the illustrated example extends coaxially to the first pivot axis S1 of the front pivot lever 10. In the present case, the axle 13 defines the first pivot axis S1.

Furthermore, the adjusting device 1 comprises a coupling element 12 which is mounted on the axle 13 so as to be movable between a coupling position and a decoupling position.

In the coupling position, the coupling element 12 produces a coupling between the drive element 11 and the pivot lever 10 for pivoting the pivot lever 10 about the first pivot axis S1. In the decoupling position, this coupling of the first pivot lever 10 with the drive element 11 is opened via the coupling element 12. In the coupling position of the coupling element 12, a rotation of the drive element 11 about the axle 13 hence is (firmly) coupled with a rotation of the front pivot lever 10 about the axle 13. In the decoupling position of the coupling element 12, the front pivot lever 10 is rotatable about the axle 13 independently of the drive element 11 (namely pivotable, in particular between the positions shown in FIGS. 2A and 2B).

FIGS. 2A and 2B show the coupling element 12 each in the coupling position. In this position, pins 120 of the coupling element 12 engage into openings 110 in the drive element 11. The coupling element 12 and the drive element 11 thereby are positively connected to each other with respect to a rotation about the axle 13. In the illustrated example, five pins 120 and five corresponding openings 110 are provided, wherein other numbers also are conceivable.

The front pivot lever 10 furthermore includes a pivot bearing 101 with a screw 103, on which the seat part 20 is pivotally mounted.

Furthermore, the adjusting device 1 comprises a decoupling element 14 for transferring the coupling element 12 between the coupling position and the decoupling position.

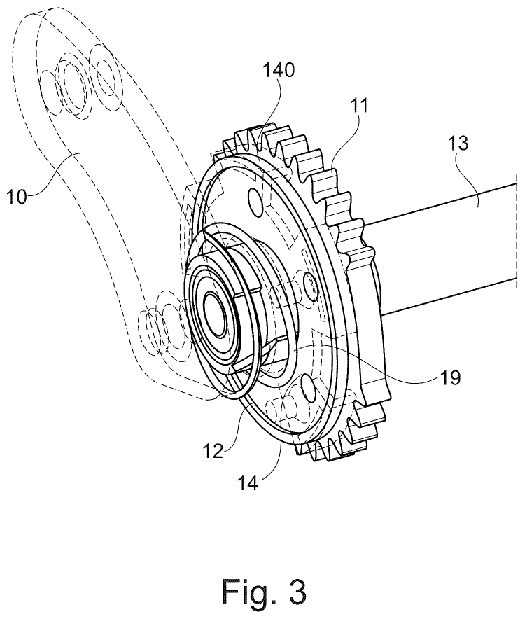

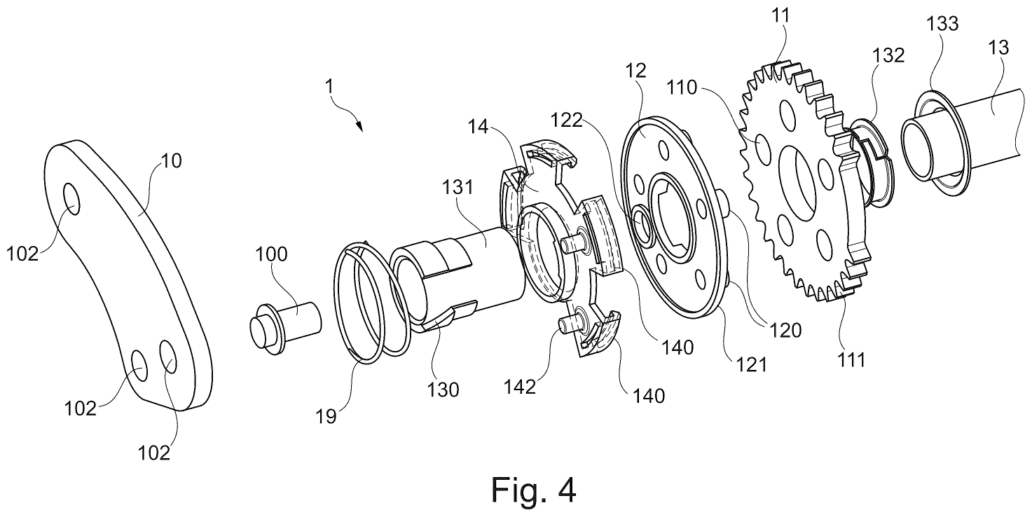

The configuration of the decoupling element will now be explained in detail with respect to FIGS. 3 and 4.

A bearing sleeve 131 is plugged onto the axle 13. In the present case, the bearing sleeve 131 is firmly connected to the axle 13. The drive element 11 is rotatably mounted on the bearing sleeve 131, in the present case plugged onto the same with a central opening. Between the bearing bush 131 and the drive element 11 a socket 132 furthermore is arranged, which forms a plain bearing with the drive element 11. A ring 133 secures the drive element 11 in this arrangement.

The front pivot lever 10 includes a plurality of openings 102. In the present case, there is provided an opening 102 for the pivot bearing 101, wherein it would also be conceivable, for example, to provide the pivot bearing in some other way, e.g. to weld the same. An opening 102 is provided for attachment of the front pivot lever 10 to the axle 13, namely in the illustrated example by means of a screw. The front pivot lever 10 is (rotatably or firmly) mounted at the axial end of the axle 13. Alternatively, the front pivot lever 10 might e.g. be welded to the axle 13. An opening 102 is provided for mounting a pin 100 (here, another way of mounting or configuring a pin is also conceivable).

The pin 100 attached to the pivot lever extends parallel to the axle 13 and eccentrically thereto (likewise with respect to the first pivot axis S1).

Between the drive element 11 and the pivot lever 10 the coupling element 12 and the decoupling element 14 are arranged. The coupling element 12 in turn is arranged between the decoupling element 14 and the drive element 11.

The coupling element 12 is of disk-shaped design. It is rotatably mounted on the axle 13, in the present case on the bearing sleeve 131. Furthermore, the coupling element 12 is mounted to be axially shiftable along the axle 13 (on the bearing sleeve 131). The coupling element 12 has a shell surface 121 extending around the outside. The shell surface 121 describes a circular cylindrical shape.

The decoupling element 14 flatly rests against the coupling element 12. The decoupling element 14 includes a plurality of arms 140 which enclose the coupling element 12 on the outside. The decoupling element 14 is mounted on the bearing sleeve 131 on one side of the coupling element, the arms 140 reach over the shell surface 121 of the coupling element 12 and extend up to the other side of the coupling element 12. The decoupling element 14 thus is positively held at the coupling element 12, but it is rotatable relative thereto. In such a rotary movement, the arms 140 slide along the shell surface 121.

A spring 19, here a spiral spring, on the one hand is supported on the front pivot lever 10 and on the other hand is pretensioned against the decoupling element 14. The spring 19 urges the decoupling element 14 with the coupling element 12 against the drive element 11. Thus, the spring 19 urges the pins 120 of the coupling element 12 into engagement with the openings 110 of the drive element 11, which are formed to match the pins 120. It should be noted that pins and openings might also be provided the other way round and other form-fit elements might also be provided.

In the coupling position, the coupling element 12 is positively in engagement with the drive element 11 for torque transmission. In the decoupling position, the coupling element 12 is out of engagement with the drive element 11 and is rotatable relative thereto.

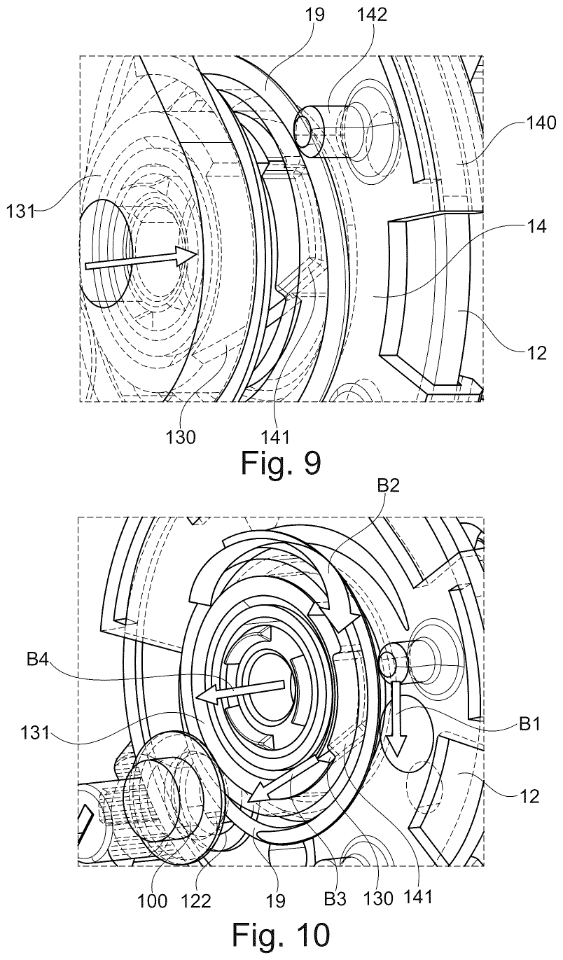

To transfer the coupling element 12 from the coupling position into the decoupling position, a slope 130 is provided on the axle 13. In the present case, the slope 130 is formed on the bearing sleeve 131. The decoupling element 14 also includes a slope 141, see in particular FIGS. 9 and 10. The two slopes 130, 141 extend around the first pivot axis S1, in the present case corresponding to the portion of a helix. The two slopes 130, 141 rest against each other. When the decoupling element 14 is rotated about the first pivot axis S1, the slope 141 of the decoupling element 14 slides along the slope 130 of the axle 13. The decoupling element 14 thereby is displaced along the axle 13, in the present case screwed along the same. As the coupling element 12 is mounted so as to be shiftable between the coupling position and the decoupling position relative to the pivot lever 10 and to the drive element 11, the same is entrained by the decoupling element 14 along the axle 13. In the process, the decoupling element 14 rotates relative to the coupling element 12.

Both in the coupling position and in the decoupling position the coupling element 12 is in engagement with the pin 100 attached to the pivot lever 10. The pin 100 is plugged into an opening 122 of the coupling element 12. During the adjustment between the coupling position and the decoupling position the opening 122 slides along the pin 100.

In the present case, the decoupling element 14 includes four arms 140. Each of the arms 140 protrudes radially to the outside, then extends in an axial direction (across the shell portion 121 of the coupling element 12) and then again radially inwards up to an end edge pointing to the inside. Between two of the arms 140 of the decoupling element 14 a greater distance exists than between the remaining arms 140. The pin 100 of the front pivot lever 10 extends through this clearance. The clearance allows the rotation of the decoupling element far enough to slide along the slope 130, so that the coupling element 12 is transferred from the coupling position into the decoupling position.

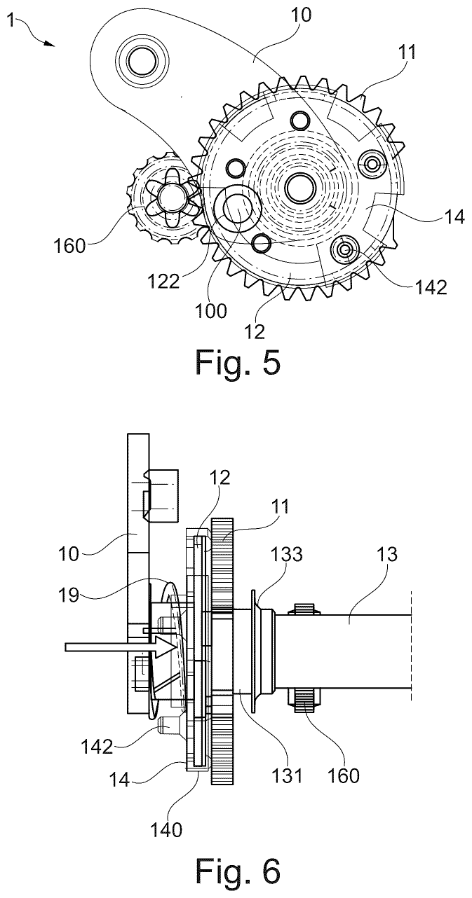

FIGS. 5 and 6 show the coupling position. The spring 19 urges the decoupling element 14 against the coupling element 12 and thus the same against the drive element 11, as is illustrated in FIG. 6 with an arrow. The pin 100 of the front pivot lever 10 is arranged on one of the two arms 140 of the decoupling element 14, which are spaced apart furthest from each other, and in the present case rests against the same.

In this position, the coupling element 12 is positively in engagement with the drive element 11 and is positively coupled with the pivot lever 10, so that a torque applied by the motor unit 16 onto the drive element 11 can be transmitted via the coupling element 12 to the pivot lever 10 for pivoting the pivot lever 10 about the first pivot axis S1.

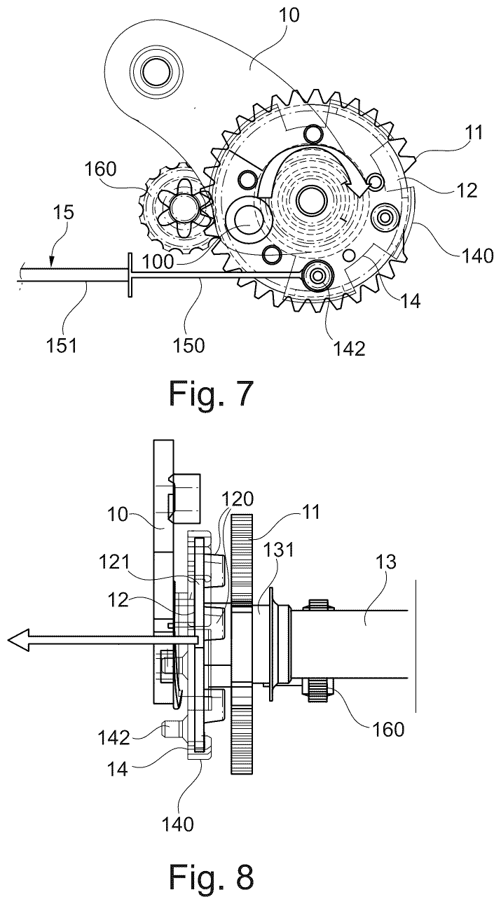

When, as is illustrated in FIG. 7 by means of an arrow, the decoupling element 14 now is rotated relative to the front pivot lever 10, the two slopes 130, 141 slide along each other. The rotation of the decoupling element 14 in the present case is effected by the Bowden cable 15 mentioned already. For this purpose, a traction cable 151 of the Bowden cable 15 is connected to the decoupling element 14, namely in the concrete example attached to a pin 142 of the decoupling element 14. The pin 142 of the decoupling element 14 axially protrudes from the same. The traction cable 151 extends in an envelope 150, which e.g. is supported on the base 21. The traction cable 151 is connected to the actuating portion 152 via its other end.

As a result of the rotation of the decoupling element 14, the same is displaced along the axle 13, whereby the coupling element 12 is shifted along the axle 13 and hence withdrawn from the drive element 11, as is illustrated by an arrow in FIG. 8. In the decoupling position then reached, the coupling element 12 thus is not in engagement with the drive element 11.

By an actuation of the actuating portion 152, both the locking mechanism 17 is unlocked and the coupling element 12 is moved into the decoupling position.

With an arrow, FIG. 9 illustrates the pressure of the spring 19 onto the decoupling element 14, as a result of which the coupling element 12 is urged into the coupling position. The slopes 130, 141 rest against each other with a respective end portion. An area of the slope 130 of the axle 13 facing the front pivot lever 10 is exposed.

FIG. 10 on the other hand illustrates the movements of the decoupling element 14 as a result of an actuation (by means of the Bowden cable 15). First, there is a pull by means of the traction cable 151 (movement B1). The same results in a rotation of the decoupling element 14 (movement B2). The slope 141 of the decoupling element 14 thereby slides along the slope 130 of the axle 13 (movement B3), which results in a displacement of the decoupling element 14 and hence of the coupling element 12 along the axle 13 (movement B4).

The gradient of the slopes 130, 141 is e.g. 40°. The spring 19 exerts e.g. a force of 100 N or more. The decoupling element 14 is made e.g. of polypropylene with 30% glass fiber (PP GF30). The drive element 11, the coupling element 12, the bearing sleeve 131 and/or the pivot levers 10, 18 are made of steel, for example.

The described solution allows an easy entry and exit also in the case of a failure of the motor unit 16. Only few parts are needed therefor. Because both for the motorized and for the manual adjustment the same mechanism is used, the total weight is low and only a small installation space is needed. An additional pivoting mechanism of the backrest 22 can be omitted, whereby the backrest 22 can be of more comfortable design and the center of gravity of the vehicle seat 2 can be lowered. Furthermore, the vehicle seat 2 can be locked in the easy-entry position by means of the coupling element, whereby an inadvertent adjustment can be prevented.

### LIST OF REFERENCE NUMERALS

1 adjusting device
10 (front) pivot lever
100 pin
101 pivot bearing
102 opening
103 screw
11 drive element
110 opening
111 tooth
12 coupling element
120 pin
121 shell surface
122 opening
13 axle
130 slope
131 bearing sleeve
132 socket
133 ring
14 decoupling element
140 arm
141 slope
142 pin
15 Bowden cable
150 envelope
151 traction cable
152 actuating portion
16 motor unit
160 pinion
17 locking mechanism
170 bolt
171 lock
18 further (rear) pivot lever
19 spring
2 vehicle seat
20 seat part
21 base
210 seat rail
211 floor rail
22 backrest
B1-B4 movement
S1-S4 pivot axis

1. An adjusting device for a vehicle seat, comprising:
a pivot lever pivotable about a pivot axis for adjustably mounting a seat part of the vehicle seat on a base of the vehicle seat,
a drive element, and
a coupling element, which is movably mounted between a coupling position in which the coupling element builds up a coupling between the drive element and the pivot lever for pivoting the pivot lever about the pivot axis, and a decoupling position in which the coupling of the pivot lever with the drive element via the coupling element is released.

2. The adjusting device according to claim 1, wherein the coupling element is mounted so as to be shiftable between the coupling position and the decoupling position relative to at least one of the pivot lever and to the drive element.

3. The adjusting device according to claim 1, wherein the drive element is configured in the form of a gear wheel.

4. The adjusting device according to claim 1, wherein the drive element is rotatably mounted on an axle.

5. The adjusting device according to claim 4, wherein the coupling element is shiftable along the axle between the coupling position and the decoupling position.

6. The adjusting device according to claim 4, further comprising a decoupling element which is rotatable about the axle relative to the coupling element and is in engagement with the coupling element in such a way that by a movement of the decoupling element the coupling element is movable along the axle between the coupling position and the decoupling position.

7. The adjusting device according to claim 6, characterized in wherein the decoupling element includes arms which enclose the coupling element.

8. The adjusting device according to claim 6, wherein the decoupling element includes a slope which rests against a slope fixed to the axle.

9. The adjusting device according to claim 6, further comprising a Bowden cable coupled with the decoupling element.

10. The adjusting device according to claim 4, wherein the axle defines the pivot axis and extends coaxially to the pivot axis.

11. The adjusting device according to claim 1, wherein in the coupling position, the coupling element is positively in engagement with the drive element and is positively coupled with the pivot lever so that a torque applied onto the drive element can be transmitted to the pivot lever via the coupling element for pivoting the pivot lever about the pivot axis.

12. The adjusting device according to claim 11, wherein in the decoupling position the coupling element is out of engagement with the drive element and is rotatable relative to the drive element.

13. The adjusting device according to claim 1, wherein the coupling element includes pins for engagement with openings of the drive element for building up the coupling of the pivot lever with the drive element via the coupling element in the coupling position.

14. The adjusting device according to claim 1, wherein both in the coupling position and in the decoupling position the coupling element is in engagement with a pin attached to the pivot lever.

15. The adjusting device according to claim 1, wherein the coupling element is pretensioned into the coupling position by means of a spring.

16. The adjusting device according to claim 1, further comprising a motor unit adapted for driving the drive element.

17. A vehicle seat comprising a seat part and a base, comprising the adjusting device according to claim 1, wherein the seat part is supported on the base via the pivot lever of the adjusting device.

18. The vehicle seat according to claim 17, wherein the adjusting device comprises at least one further pivot lever which forms a four-bar linkage with the pivot lever.

19. The vehicle seat according to claim 17, wherein the adjusting device comprises an actuating portion and a locking mechanism by means of which the seat part can be locked with the base, wherein by an actuation of the actuating portion both the locking mechanism can be unlocked and the coupling element can be moved into the decoupling position.

20. The vehicle seat according to claim 17, wherein jointly with a backrest of the vehicle seat the seat part can be moved by means of the adjusting device from a position of use to be occupied into an entry position folded forwards relative thereto with respect to the base.
